(19) United States
(12) Patent Application Publication
(10) Pub. No.: US 2013/0246268 A1
(43) Pub. Date: Sep. 19, 2013

(54) METHOD AND SYSTEM FOR DEDICATED SECURE PROCESSORS FOR HANDLING SECURE PROCESSING IN A HANDHELD COMMUNICATION DEVICE

(71) Applicant: Mehran Moshfeghi, Rancho Palos Verdes, CA (US)

(72) Inventor: Mehran Moshfeghi, Rancho Palos Verdes, CA (US)

(21) Appl. No.: 13/421,182

(22) Filed: Mar. 15, 2012

(51) Int. Cl. G06Q 20/40; G06Q 20/38

(52) U.S. Cl. 705/44; 705/39

(57) ABSTRACT

A communication device may comprise one or more dedicated secure processors and one or more other non-secure processors. The one or more dedicated secure processors may be utilized for handling secure transactions in the communication device. Each of the dedicated secure processors may run independent of the other processors in the communication device, and may utilize dedicated software that is unique for a particular payment provider for handling of secure transactions. The dedicate software may comprise a dedicated operating system and/or application for use in handling the secure transactions. Each of the dedicated secure processors may utilize dedicated resources in the communication device during handling of secure transactions. Handling secure transactions may comprise authenticating the user and/or the transactions, based on information relating to and/or provided by the user.

### CLAIM OF PRIORITY

[Not Applicable].

### CROSS-REFERENCE TO RELATED APPLICATIONS/INCORPORATION BY REFERENCE

[Not Applicable].

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to communications. More specifically, certain embodiments of the invention relate to a method and a system for dedicated and secure processors for handling secure transactions and computations/communications in a handheld communication device.

### BACKGROUND OF THE INVENTION

The field of communication has seen dramatic growth the last few decades. Many new communication technologies, standards, and/or systems, wired based or wireless, have been developed and have entered the market. In today's society, most people are almost always connected, via various personal wired and/or wireless communication devices that have become almost standard personal equipment, such as personal computers, laptops, cellular phones, smartphones, tablets and the like. Furthermore, nowadays people use their communications devices for various purposes, business and personal, on a constant and daily basis. In this regard, communication devices have gone beyond simply being used for simple, traditional communication uses (e.g., voice calls) to being used for many other purposes and/or uses, especially when used in accessing and using interconnected networks and/or systems, such as the Internet or work intranets.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for dedicated secure processor for handling secure transactions in a handheld communication device, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary communication setup for utilizing communication devices with dedicated secure transaction processing, in accordance with an embodiment of the invention.

FIG. 2A is a block diagram illustrating an exemplary communication device that incorporates dedicated secure transaction processing, in accordance with an embodiment of the invention.

FIG. 2B is a block diagram illustrating an exemplary communication device that is operable to utilize a bank of secure processors for dedicated secure transaction processing, in accordance with an embodiment of the invention.

FIG. 2C is a block diagram illustrating an exemplary communication device that incorporates dedicated secure transaction processing with dedicated communication path for secure transactions, in accordance with an embodiment of the invention.

FIG. 3 is a block diagram illustrating an exemplary user authentication module that is operable to support secure transaction processing in a communication device, in accordance with an embodiment of the invention.

FIG. 4 is a flow chart that illustrates exemplary steps for securing transactions in a communication device, in accordance with an embodiment of the invention.

### DETAILED DESCRIPTION OF THE INVENTION

Certain embodiments of the invention may be found in a method and system for dedicated secure processor for handling secure transactions in a handheld communication device. In various embodiments of the invention, in a communication device that may comprise one or more dedicated secure processors, and one or more other processors, the one or more dedicated secure processors may be utilized to handle secure transactions for users of the communication device. In this regard, each of the one or more dedicated secure processors may operate independent of the one or more other processors in the communication device, and may utilize dedicated software and/or operating system that is unique for a particular payment provider for handling of secure transactions. The secure transactions may be initiated and/or requested by a user of the communication device. A particular secure processor from the one or more dedicated secure processors may be selected to handle a particular secure transaction. At least some of the dedicated secure processors may be operable to concurrently handle a plurality of secure transactions. While some of the embodiments of the inventions are described with respect to secure transactions, the scope of the invention may go beyond secure transactions. In this regard, in accordance with other embodiments of the invention, dedicated and/or different secure processors may be utilized to incorporate and/or run different software applications (e.g., Smartphone Apps). In some instances, such software applications may comprise transaction processing applications (e.g., banking Apps). However, other types of software applications may also be implemented and/or run by the secure processors, such as (i) email processing Apps, (ii) phonebook management software, (iii) location/positioning Apps. In one embodiment of this invention, different secure processors in a particular communication device may be allocated and/or assigned to different groups of software applications. For example, a first secure processor may be allocated to mobile banking Apps, a second secure processor may be allocated to email management Apps, and a non-secure processor may be allocated to non-secure gaming Apps.

Each of the one or more dedicated secure processors may utilize one or more dedicated resources in the communication device during handling of secure transactions. The dedicated resources may comprise storage resources. The one or more dedicated resources may comprise separate physical components used only by the one or more dedicated secure processors, and/or dedicated resources that may be allocated or partitioned from commonly shared components in the communication device. During the handling of the secure transaction, communication pertaining to the secure transaction may be performed via a communication subsystem shared with other components in the communication device, and/or via a dedicated communication subsystem, which may be utilized only for handling secure transactions. During handling of the secure transaction, the user and/or the transaction or request thereof may be authenticated. The authentication of the user and/or the transaction may be based on information related to and/or provided by the user. The information may comprise one or more of biometric data, user access information, and security access information. In one embodiment, the communication system may be duplicated for the baseband processor sub-system while the RF and antenna sub-system may be shared. Use of only dedicated baseband processor may be possible and/or desirable due to the fact that tracking of communication transaction may only be possible through baseband processor MAC ID and not through the RF sub-system. For example, the device may deploy only one RF/antenna sub-system and two baseband processors (each with a separate MAC ID and SIM card). In this regard, one baseband processor may be utilized for non-secure applications while the other one may be utilized only for secure applications (therefore keeping communication channels highly secure and separate).

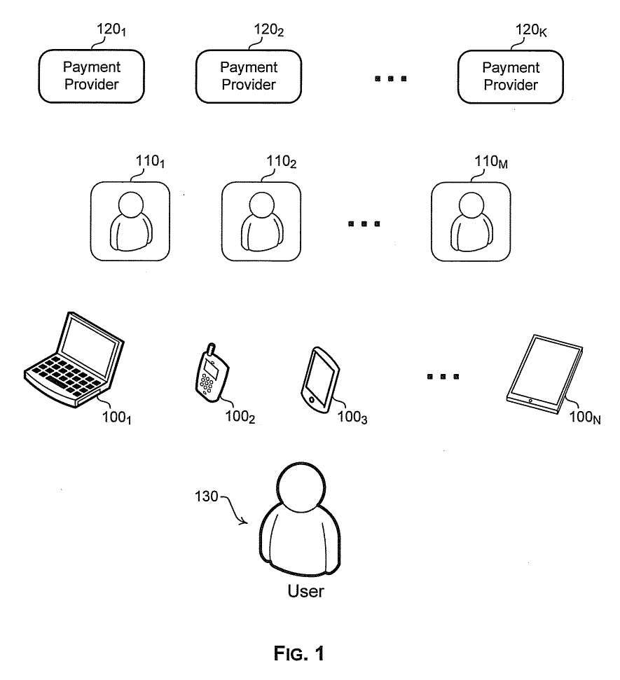

FIG. 1 is a block diagram illustrating an exemplary communication setup for utilizing communication devices with dedicated secure transaction processing, in accordance with an embodiment of the invention. Referring to FIG. 1, there is a user 130, a plurality of communication devices 100₁-100_{N}, a plurality of vendors 110₁-110_{M}, and a plurality of payment providers 120₁-120_{K}.

Each of the communication devices 100₁-100_{N} may comprise suitable logic, circuitry, interfaces, and/or code operable to communicate via wired and/or wireless connections, in accordance with supported wired and/or wireless protocols or standards. Exemplary communication devices may comprise laptop computers (e.g., device 100₁), cellular phones (e.g., device 100₂), smartphones (e.g., device 100₃), and/or tablets (e.g., device 100_{N}). The invention, however, is not limited to any particular type of communication devices. In addition to performing communication operations, the communication devices 100₁-100_{N} may be operable to perform additional functions, which may be related to applications that are run or executed in these devices, and/or based on user interactions with the devices. In an exemplary aspect of the invention, the communication devices 100₁-100_{N} may incorporate dedicated secure components for handling secure transactions. In this regard, the secure components may comprise dedicated secure processors which may be operable and/or configured to run and/or operate independent of other components of the communication devices 100₁-100_{N}, and incorporating functions required for performing transactions for users of the communication devices 100₁-100_{N}.

Each of the vendors 110₁-110₁₀ may provide particular goods, products, merchandise and/or services that may be obtained and purchased by the user 130. Exemplary vendors may comprise food venders, access providers, online retailers, and the like. The invention, however, is not limited to any particular type of vendor.

Each of the payment providers 120₁-120_{K} may provide, facilitate, and/or ensure payments, such as with respect to transactions by users (e.g., user 130) when purchasing goods, products, merchandise and/or services. Exemplary payment providers may comprise credit card issuers, banks, online payment service providers (e.g., PayPal), and/or other financial or merchant entities. The invention, however, is not limited to any particular type of payment provider.

In operation, the communication device 100₁-100_{N} may be utilize or perform wireless and/or wired communications. In this regard, the communication devices 100₁-100_{N} may be operable to transmit and/or receive signals, wirelessly or via wired connections, to facilitate sending and/or receiving data from and/or to the devices. Various wired and/or wireless technologies, protocols, and/or standards may be supported and/or utilized during communication operations by the communication device 100₁-100_{N}. In addition to performing communication operations, the communication devices 100₁-100_{N} may be operable to perform additional functions. Exemplary additional function may be related to applications that are run or executed in these devices, and/or based on user interactions with the devices. In an exemplary aspect of the invention, the communication device 100₁-100_{N} may support secure transactions by user(s) of the devices. In this regard, securing transactions may comprise ensuring that payment and/or personal related information are exchanged (when needed) in secure manner so that personal and financial information is not compromised and is kept confidential. For example, secure transactions comprise communicating such information as account numbers, user identification data, access information (e.g., passwords or security phrases) and the like, so that they are not exposed to unintended parties. Furthermore, securing transactions may comprise, in addition to ensuring secure communication of data, handling information pertinent to the transactions securely within the communication devices 100₁-100_{N}—e.g., the transactions related information is handled in manner whereby it is protected and hidden from non-secure component, which may be utilized to gain unauthorized access to that information. In other words, during secure transactions, various measures may be taken to also hide and/or protect information pertinent to the transactions within the communication devices 100₁-100_{N}, to guard against the information becoming accessible through other, non-secure components of the communication devices 100₁-100_{N}.

In various embodiments of the invention, the communication devices 100₁-100_{N} may be configured to incorporate dedicated secure components for handling secure transactions. In this regard, such secure components may incorporate functions required for performing the requested transactions, and may be operable and/or configured to run and/or operate independent of other components of the communication devices 100₁-100_{N}. In this manner, use of such dedicated secure components may ensure that any information generated, obtained, and/or utilized during secured transactions handled by the dedicated secure components would remain protected, and are exposed to unwanted access, such as via other, non-secure components of the communication devices 100₁-100_{N}. For example, the dedicated secure components may comprise one or more dedicated secure processors that are operable to run independent of other processors or other similar components in the communication devices 100₁-100_{N}. The dedicated secure processors may, for example, run operating systems that are separate and/or distinct from main operating system running in the communication devices 100₁-100_{N}, such as in any core or main processors incorporated therein. Furthermore, the secure processors may incorporate and/or run software that is uniquely used in supporting secure transactions. For example, the software may comprise applications that are unique to particular vendors, in order to handle vendor specific transactions, and/or to particular payments source, in order to provide and/or support any compensation associated with the transactions. In some embodiments, the operating system used for a secure application may be used exclusively for that application and provided by the vendor providing the secure application. As an example, Citibank provides a mobile banking application along with an operating system to run the application. The OS and the application would then be installed and operated on a secure processor.

In one embodiment of the invention, the secure processors may have a dedicated memory that is utilized solely for the purpose of handling secure transactions. In one aspect of the invention, each secure processor may have its own corresponding secure memory that is dedicated to handling secure processing operations. In another aspect of the invention, the secure processors may utilize a single dedicated memory that is operable to handle secure processing for all of the secure processors. In this regard, each of the dedicated processor may be assigned to utilize a particular area of the single dedicated memory. Accordingly, a particular secure processor does not have access to regions of the single dedicated memory that are not assigned to it. In another aspect of the invention, the secure processors and other non-secure processors may share a single memory, in which only portions of the shared memory may be operable to handle secure processing for the secure processors. In this regard, each of the dedicated secure processors may be assigned a particular area of the single dedicated memory that is only accessible by that secure processor (i.e., inaccessible by other secure processor and/or non-secure processors, and with that particular secure processor not have access to regions of the single dedicated memory that are not assigned to it. The memory partitioning between the secure and unsecure processors can be implemented through a hardware arbitrator (for maximum security) or a software arbitrator (for lower cost)

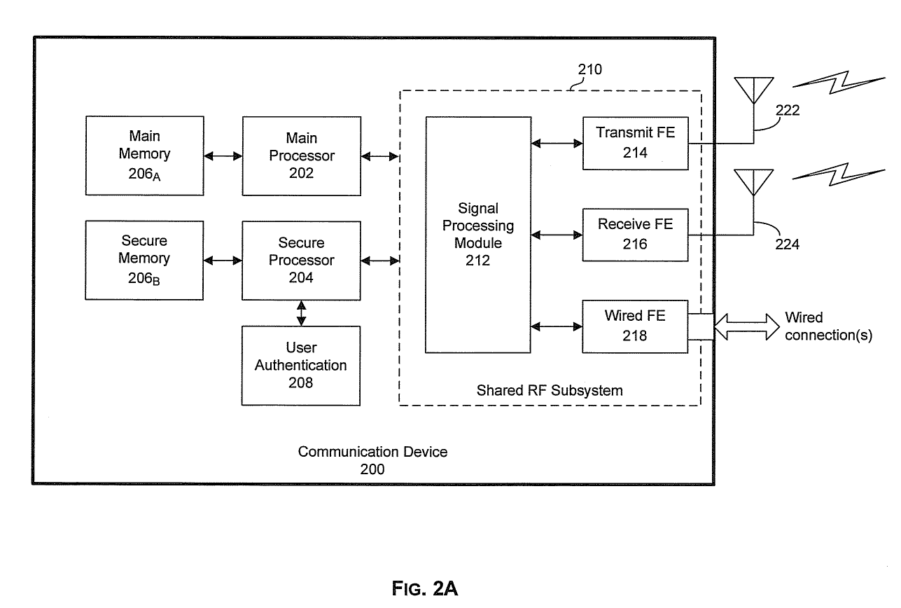

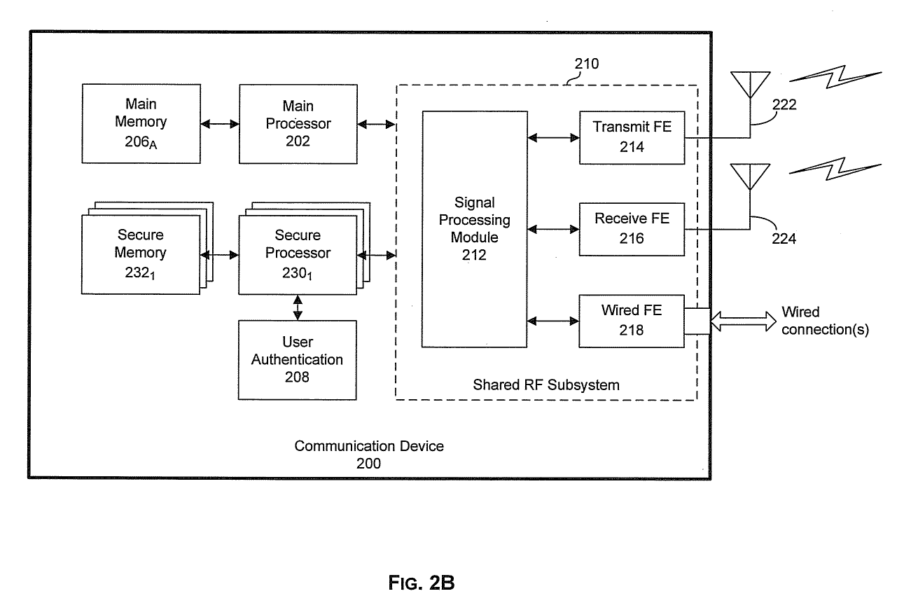

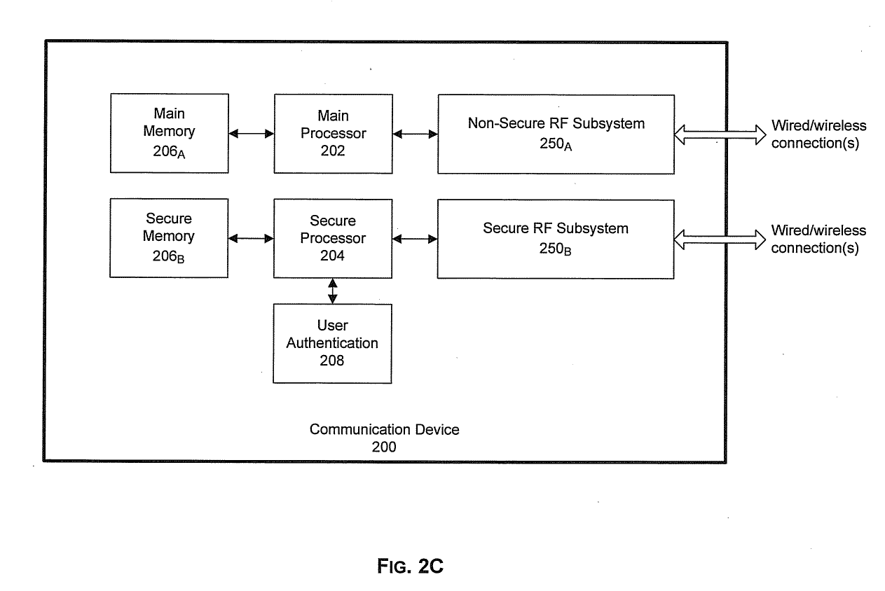

FIG. 2 is a block diagram illustrating an exemplary communication device that incorporates dedicated secure transaction processing, in accordance with an embodiment of the invention. Referring to FIG. 2 there is shown a communication device 200.

The communication device 200 may comprise suitable logic, circuitry, interfaces, and/or code that may be operable to implement various aspects of the invention. In this regard, the communication device 200 may correspond to each of the communication devices 100₁-100_{N} of FIG. 1. The communication device 200 may comprise, for example, a main processor 202, a secure processor 204, a system memory 206_{A} and a dedicated secure memory 206_{B}, a user authentication module 208, a signal processing module 212, transmit front-end (FE) 214, a receive front-end (FE) 216, a wired front-end (FE) 218, a transmission antenna 222, and a reception antenna 224.

The main processor 202 may comprise suitable logic, circuitry, interfaces, and/or code that may be operable to process data, and/or control and/or manage operations of the communication device 200, and/or tasks and/or applications performed therein. In this regard, the main processor 202 may be operable to configure and/or control operations of various components and/or subsystems of the communication device 200, by utilizing, for example, one or more control signals. The main processor 202 may enable execution of applications, programs and/or code, which may be stored in the system memory 204, for example.

The secure processor 204 may comprise suitable logic, circuitry, interfaces, and/or code that may be operable to perform and/or manage secure transaction operations in the communication device 200. In this regard, the secure processor 204 may be operable to run and/or execute any software (e.g., applications) uniquely utilized in performing and/or supporting secured transactions. In an embodiment of the invention, the secure processor 204 may run an operating system (OS) that is distinct from, and runs independent of a primary operating system of the communication device 200, which may be run via the main processor 202 for example.

Each of the system memory 206_{A} and the dedicated secure memory 206_{B} may comprise suitable logic, circuitry, interfaces, and/or code that may enable permanent and/or non-permanent storage, buffering, and/or fetching of data, code and/or other information, which may be used, consumed, and/or processed. In this regard, the system memory 206_{A} and dedicated secure memory 206_{B} may comprise different memory technologies, including, for example, read-only memory (ROM), random access memory (RAM), Flash memory, solid-state drive (SSD), and/or field-programmable gate array (FPGA). The system memory 204 may store, for example, configuration data, which may comprise parameters and/or code, comprising software and/or firmware. The use of separate memory components, for secure and non-secure operations, may enhance security with respect to certain operations (e.g., financial or merchant transactions by users). In an embodiment of the invention, instead of using separate physical memory components, a single memory may be utilized, with the separation between secure and non-secure storage being achieved by use of secure partitioning. In this regard, secure partitioning may comprise partitioning and apportioning, physically and/or logically, different sections of a shared memory, with at least some of the portions being made accessible only by component(s) assigned to these portions. This may be achieved by any available memory management scheme. Thus, use of secure partitioning, particular portions of a shared memory device may be made dedicated for secure use, with its access being completely blocked to components not part of the secure processing path.

The user authentication module 208 may comprise suitable logic, circuitry, interfaces, and/or code that may be operable to perform user authentication related operations in the communication device 200. In this regard, user authentication related operations may be directed at authenticating users associated with the communication device 200 and/or various actions by the users, such as when initiating and/or conducting secured transactions by the communication device 200. For example, the user authentication module 208 may be operable to obtain user information pertinent to authentication of users, and/or to utilize that information in enabling authentication transactions involving the users.

The signal processing module 212 may comprise suitable logic, circuitry, interfaces, and/or code operable to process signals transmitted and/or received by the communication device 200, in accordance with one or more wired or wireless protocols supported by the communication device 200. The signal processing module 212 may be operable to perform such signal processing operation as filtering, amplification, up-conversion/down-conversion of baseband signals, analog-to-digital conversion and/or digital-to-analog conversion, encoding/decoding, encryption/decryption, and/or modulation/demodulation. The signal processing module 212, along with the transmit FE 214, The transmit FE 214, and The transmit FE 214 may collectively constituted a shared RF subsystem 210 that is commonly utilized by other components of the communication device 200 for communicating data to and/or from the communication device 200.

The transmit FE 214 may comprise suitable logic, circuitry, interfaces, and/or code that may be operable to perform wireless transmission, such as over a plurality of supported RF bands. The transmit FE 214 may enable, for example, performing wireless communications of RF signals via the transmission antenna 222. In this regard, the transmission antenna 222 may comprise suitable logic, circuitry, interfaces, and/or code that may enable transmission of wireless signals within certain bandwidths and/or in accordance with one or more wireless interfaces supported by the communication device 200.

The receive FE 216 may comprise suitable logic, circuitry, interfaces, and/or code that may be operable to perform wireless reception, such as over a plurality of supported RF bands. The receive FE 216 may enable, for example, performing wireless communications of RF signals via the reception antenna 224. In this regard, the reception antenna 224 may comprise suitable logic, circuitry, interfaces, and/or code that may enable reception of wireless signals within certain bandwidths and/or in accordance with one or more wireless interfaces supported by the communication device 200.

The wired FE 218 may comprise suitable logic, circuitry, interfaces, and/or code that may be operable to perform wired based transmission and/or reception, such as over a plurality of supported physical wired media. The wired FE 218 may enable communications of RF signals via the plurality of wired connectors, within certain bandwidths and/or in accordance with one or more wired protocols (e.g. Ethernet) supported by the communication device 200.

In operation, the communication device 200 may be configured to support secure handling of transactions using the secure processor 204. In this regard, the communication device 200 may incorporate various features and/or mechanisms to ensure that a transaction pertaining to a user of the communication device 200 is handed securely by the secure processor 204. Specifically, handling transactions securely may comprise performing the transaction in a manner that may ensure that functions and/or information utilized during handling of the transaction are maintained safe and/or are protected from unwanted access, even if inadvertent, directly or via other components in the communication device 200. Secure handling may comprise, for example, obtaining, generating, and/or utilizing user and/or payment related information such that the information cannot be accessed by non-secure components of the communication device 200. The secure processor 204 may be configured, for example, to run independent from other processors in the communication device 200. This may be achieved by having the secure processor 204 incorporate all functions required for performing the transactions, and/or by having the secure processor 204 run an operating system that is a separate and distinct from the operating system running in the communication device 200, such as by the main processor 202.

The secure processor 204 may be configured to run dedicated software that is uniquely utilized when handling particular transactions. For example, the secure processor 204 may be configured to run a dedicated application that may be utilized when performing transactions involving particular vendor 110ᵢ, and/or in which payment is obtained from a particular payment provider 120ᵢ. The application may be downloaded from the particular vendor 110ᵢ and/or the particular payment provider 120ᵢ. The secure processor 204 may be operable to run a single application and/or a group of applications, each being unique to specific vendor and/or payment provider. In some instances, the secure processor 204 may be operable to run more than one application at the same time—i.e., may concurrently support handling multiple secure transactions.

The secure processor 204 may also be assigned and/or allocated dedicated resource(s) for use during handling of secure transactions, as deemed necessary to further ensure the security of the transactions by preventing use of common resources in a manner that exposes any functions or data to other non-secure components. For example, the secure processor 204 may be allocated the dedicated secure memory 206_{B}, which may be used to store information utilized during handling of secure transactions in a secure manner—i.e., being inaccessible by other non-secure component in the communication device 200.

In an embodiment of the invention, during handling of secure transactions, information pertaining to the transactions may be parsed, to enable dividing processing of information, and/or other aspects or functions of handling the transaction, among secure and non-secure components. In this regard, dividing the handling of a transaction between secure and non-secure components may result in more efficient use of the resources when handling transactions. For example, data pertaining to a requested transaction may be parsed into secure transaction data, and other non-secure data, such as graphics related data—e.g., data pertaining to graphics displayed showing available choices and/or allowing inputting of user selection(s). Accordingly, to expedite handling of the transactions, the secure transaction data may be stored into the secure memory 206_{B} and may be assigned to the secure processor 204 to be processed thereby, whereas the non-secure data (graphics) may be stored into the (non-secure) main memory 206_{A} and may be assigned to the (non-secure) main processor 202 for processing thereby.

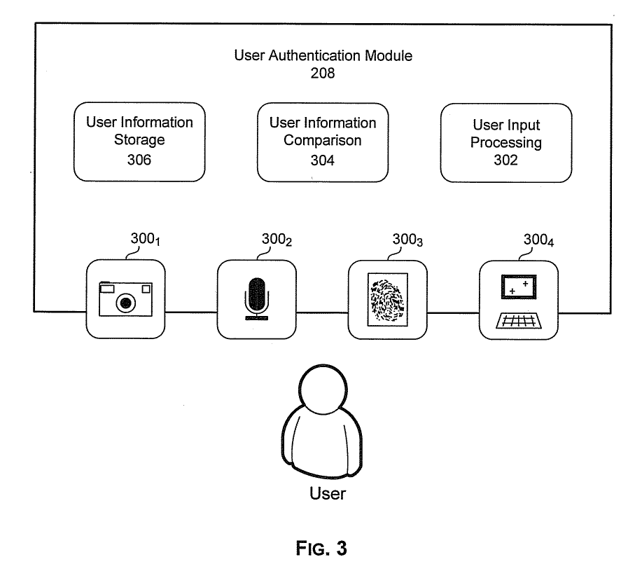

In an embodiment of the invention, handling secure transactions may comprise use of authentication, which may be directed at authenticating the user and/or various actions by the user, such as when initiating and/or conducting secured transactions using a device, such as the communication device 200. In this regard, the user authentication module 208 may be utilized to perform the necessary authentication operations. For example, user authentication module 208 may capture, obtain, and/or generate user related information, and utilize that information to perform user authentication. The user related information may comprise user identification information and/or user access validation information. This is described in more details in FIG. 3.

FIG. 2B is a block diagram illustrating an exemplary communication device that is operable to utilize a bank of secure processors for dedicated secure transaction processing, in accordance with an embodiment of the invention. Referring to FIG. 2B, there is shown an alternative implementation of the communication device 200, which incorporates a plurality of secure processors.

The communication device 200 may comprise a plurality (bank) of secure processors 230₁-230_{N}, and corresponding plurality (bank) of security memories 232₁-232_{N}. In this regard, each of the secure processors 230₁-230_{N} may be substantially similar to the secure processor 204 of FIG. 2, and each of the security memories 232₁-232_{N} may be substantially similar to the secure memory 206_{B} of FIG. 2. In this regard, the security memories 232₁-232_{N} may correspond to separate and distinct memory devices (e.g., different flash memories), and/or may corresponding to separate and distinct partitions, physical and/or logical, in a common, shared memory device. The shared memory may correspond to a shared secure memory device that is separate from other memory devices utilized by non-secure components of the communication device 200; or it may correspond to a single memory device (or system) that is shared by all components of the communication device 200. In instances where the security memories 232₁-232_{N} may correspond to separate and distinct partitions of a single shared memory device, memory management techniques may be implemented to ensure that each of these partitions are only accessible by the corresponding, assigned secure processor.

In operation, the communication device 200 may be configured to support secure handling of transactions using the plurality of the secure processors 230₁-230_{N}. In this regard, each of the secure processors 230 may be operable to handle secure transactions in substantially the same manner as described with respect to secure processor 204, and with respect to FIG. 2A. In an embodiment of the invention, the secure processors 230₁-230_{N} may be configured such that at least some of the secure processors 230₁-230_{N} may be utilized in handling any secure transaction, as such these secure processors may be allocated to handle any secured transactions on per-need basis. In other words, whenever a secure transaction is initiated by a user of the communication device 200, any available secure processor 230ᵢ may be selected to handle that transaction. The selection may be based on availability and/or based on load balancing criteria.

In an embodiment of the invention, one or more of the secure processor 230 may be configured to handle only certain secure transactions, such as transactions pertaining to particular vendor(s) and/or particular payment provider(s). For example, the secure processor 230₁ may be configured to only handle transactions pertaining to vendor 110₂ and/or payment provider 120_{K}. To that end, a secure processor 230ᵢ may be setup to run one or more particular functions and/or applications that are specific to corresponding particular one or more transactions. Accordingly, the selection of the secure processor when a secure transaction is initiated may be based on correlation between the secure processors and particular vendors and/or payment providers.

In an embodiment of the invention, each of secure processors 230₁-230_{N} may be allocated and/or assigned corresponding dedicated resource(s) for use during handling of secure transactions. For example, each of the secure processors 230₁-230_{N} may be allocated and/or assigned a dedicated one of the security memories 232₁-232_{N}. In this regard, to further enhance protection of information utilized during handling of secure transactions, data utilized in a secure processor 230ᵢ during such handling is stored in corresponding secure memory 232ᵢ, which is inaccessible by any of the other secure processors, or any other non-secure component in the communication device 200.

FIG. 2C is a block diagram illustrating an exemplary communication device that incorporates dedicated secure transaction processing with dedicated communication path for secure transactions, in accordance with an embodiment of the invention. Referring to FIG. 2C, there is shown an alternative implementation of the communication device 200, incorporating separate, dedicated RE subsystems for use in secure operations.

The communication device 200 may comprise a non-secure RF subsystem 250_{A}, and a secure RF subsystem 250_{B}. In this regard, each of the non-secure RF subsystem 250_{A} and the secure RF subsystem 250_{B} may be substantially similar to the RF subsystem 210 of FIG. 2.

In operation, communications during handling of secure transactions by the secure processors (e.g., secure processor 204) in the communication device 200 may be carried via a dedicated communication path, such as via the secure RF subsystem 250_{B}. In this regard, access to the secure RF subsystem 250_{B}, for transmission and/or reception of data, may be restricted to security components (e.g., the secure processor 204) in the communication device 200. Other, non-secure components, such as the main processor 202, may be specifically configured to utilize the non-secure RF subsystem 250_{B}, for transmission and/or reception of data. This may further ensure that access to information pertinent to secure transactions is shielded from unwanted access, such as via non-secure components and/or functions or applications thereof, during data communications.

In one embodiment of the invention, to further separate and/or distinguish communications corresponding to secure transactions and non-secure operations in the communication device 200, the secure RF subsystem 250_{B} may be assigned addressing parameters (e.g., MAC address) that are unique and distinct from the addressing parameters associated with the non-secure RF subsystem 250_{A}. This results in the communications performed by each of these subsystems appearing as if they pertain to different communication devices. In other words, the communication device 200 may essentially be given, by assigning the secure RF subsystem 250_{B} unique network addressing parameters, a unique identity for use in secure communications.

FIG. 3 is a block diagram illustrating an exemplary user authentication module that is operable to support secure transaction processing in a communication device, in accordance with an embodiment of the invention. Referring to FIG. 3, there is shown the user authentication module 208 of FIG. 2.

The user authentication module 208 may comprise a plurality of user input modules 300₁-300₄, a user input processing module 302, a user information comparison module 304, and a user information storage 306.

The plurality of user input modules 300₁-300₄ may comprise suitable logic, circuitry, interfaces, and/or code for capturing, obtaining, and/or generating information associated with a particular user, for use in authentication operations pertaining to user interactions, for example. Exemplary user related information may comprise visual data, such as images or retina (or iris) scans, associated with the user, which may be obtained via a camera (e.g., module 300₁); user's voice or audio input, which may obtained using microphone (e.g., module 300₂); user's fingerprints, which may be obtained using a fingerprint reader (e.g., module 300₃); and/or user's tactile and/or textual input, which may be obtained using touch screen and/or keypad (e.g., module 300₄).

The user input processing module 302 may comprise suitable logic, circuitry, interfaces, and/or code that may be operable to process user-related data obtained and/or generated via the plurality of user input modules 300₁-300₄, such as to enable use of that information during user authentication operations. For example, the user input processing module 302 may enable processing video/audio input, fingerprints, and/or tactile and/or textual input, to generate user identification data. In this regard, the user input processing module 302 may enable, for example, keying on distinguishing characteristics in various types of user input that may uniquely identify users and/or actions thereby. For example, the user input processing module 302 may identify distinguishing features in captured fingerprint, and generate data that specify these features in a manner that ease any comparison thereof with previously stored fingerprint data.

The user information comparison module 304 may comprise suitable logic, circuitry, interfaces, and/or code that may be operable to identify particular users based on user inputs. For example, the user information comparison module 304 may search for and/or identify particular users by comparing user input with previously stored user information. In instances where there is a successful match, the user information comparison module 304 may indicate the user identification and/or authentication is successful.

The user information storage 306 may comprise suitable logic, circuitry, interfaces, and/or code operable to store information that is utilized in identifying and/or authenticating users. The user information storage 306 may enable, for example, storage, retrieval, and/or updating of a plurality of user profiles. Each of user profiles may correspond to particular user, and may comprise information that uniquely identify and/or authenticate that user and/or actions or activities associated with that user. Exemplary user-specific information may comprise user biometric like information (e.g., fingerprint, retina/iris scans, facial recognition, voice, speech patterns, etc.); and/or textual/ tactile information (e.g., password, security phrases, etc.). The information storage 306 may support generating new user profiles (e.g., for a new user), modifying existing user profiles, and/or deleting user profiles.

In operation, the user authentication module 208 may be utilized to capture, obtain, and/or generate user related information, and/or to utilize that information to perform user authentication related operations. In this regard, the user authentication may be directed at validating a user and/or actions by the user, such as when initiating and/or conducting transactions using the communication device 200, which comprises the user authentication module 208. The user related information may comprise information that may identify the user. User identifying information may comprise, for example, user biometric information, which may be keyed in on particular, unique features and/or characteristics. User biometric information may comprise, for example, fingerprints, iris/retina scans, video data (e.g., images for use in facial recognition), and audio data (e.g., for voice or speech pattern), which may be obtained using camera 300₁, microphone 300₂, and/or fingerprint reader 300₃. In some instances, biometric information may also comprise behavioral information. User identifying information may also comprise user access information. In this regard, the user access information may comprise user-specific input (e.g., login) that may enable validating the user. For example, user access information may comprise user identifier, password, access phrases, and secure access answers to predetermined security questions. The user input may be entered as tactile and/or textual input, via the touch screen and/or keypad module 300₄. In some embodiments, the user may define various levels of security for software applications partitioning and installations. For example, applications that may be run in particular communication device may be classified into separate categories, with applications in a first category (category 1) being considered non-secure and are therefore routed for installation on non-secure processor(s), without requiring any authentication. Such category may include utility applications such as games, etc. Applications in a second category (category 2) may require simple password authentication, may all be installed and/or processed on a particular secure processor. This category may include semi-secure applications such as emails, phonebook, etc. Applications in a third category (category 3) may require comprehensive authentication (e.g., combination of RSA, password, etc.) in order to be installed and/or processed a particular secure processor, which may be the most secure processor in the communication application. This category can include financial and banking applications.

In one embodiment of the invention, the user authentication may be based on security access mechanism. For example, the user authentication may be performed in a manner similar to the use of the RSA algorithm, whereby the user provides the correct private key, which may be read from a token and may be entered as tactile and/or textual input, via the touch screen and/or keypad module 300₄. In another embodiment, a hardware switch (or set of switches) on the communication device may be used to select the processor destination for installation and processing of an application software. For example, a user may decide to install a mobile banking app on the communication device. That application may only be authorized to get routed and installed on a particular secure processor only if the user switches the hardware switch/key on the device to “secure” position.

Once the user input is obtained; captured, or generated, it may be used, either directly or after a processing step (via the user input processing module 302), to authenticate the user, by comparing corresponding user input or any information derived therefrom, via the user information comparison module 304, with preexisting user identification and/or authentication data, which may be retrieved from the user information storage 306. In instances where the user authentication is successful, the user authentication module may inform other components of the communication device 200, such as any secure processor (e.g., secure processor 204 or any secure processor 230ᵢ), which may enable proceeding with handling of any secure transactions handled thereby.

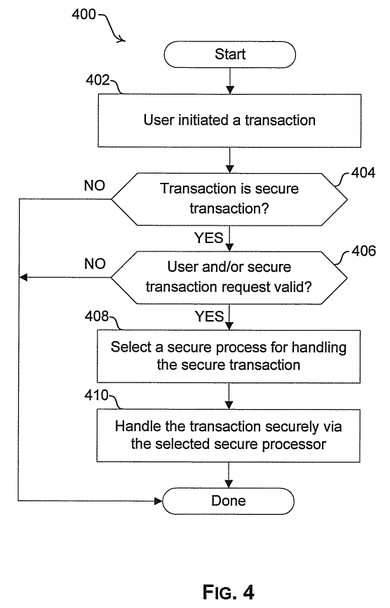

FIG. 4 is a flow chart that illustrates exemplary steps for securing transactions in a communication device, in accordance with an embodiment of the invention. Referring to FIG. 4, there is shown a flow chart 400 comprising a plurality of exemplary steps for securing user transactions in a communication device, such as communication device 200.

In step 402, a user of a communication device may initiate a transaction to be conducted via the communication device. For example, the user 130 may utilize one of the communication devices 100₁-100_{N}, to initiate a transaction, such as with one of the vendors 110₁-110_{M}, in which payment and/or compensation may be necessary, being provided and/or supported by one of the payment providers 120₁ -120_{K}. In step 404, it may be determined whether the initiated transaction should be performed in secured manner. In instances where it may be determined the transaction need not be secured, the process may terminate. Returning to step 404, in instances where it may be determined that the transaction must be secured the process may proceed to step 406. In step 406, a validation of the user and/or user's request for initiating the transaction may be performed. In this regard, the validation may comprise authentication of the user and/or the users' actions based on capturing and/or obtaining of user specific information, such as user biometric or textual input, via the user authentication module 208 for example, and use thereof in authenticating the user and/or the user's interactions. In instances where the validation of the user and/or the user's request fails, the process may terminate.

Returning to step 406, in instances where the validation of the user and/or the user's request is successful the process may proceed to step 408. In step 408, a secure processor is selected to handle the secure transaction. In this regard, the secure processor may be selected from a bank of secure processors in the communication device. The selection may be based on availability and/or load balancing criteria—i.e., the selection may be based on selecting the first available secure processor in the bank of secure processors, and/or the selection mechanism may be configured to loop through the bank of secure processors, thus selecting the next processor in the bank of secure processors following the last utilized processor. Also, the selection may be based on correlation between the secure processors and particular vendors and/or payment providers. In step 410, the secure transaction may be handled by the selected secure processor. The handling may comprise utilizing a specific software (e.g., operating system and/or application) running in the selected secure processor, which may be uniquely tailored to handle or perform the same type of transactions, with the particular vendor and/or payment provider.

The secure processor (204 or 230ᵢ) of the communication device 200 may be utilized to handle secure transactions for users of the communication device 200. In this regard, the secure processor (204 or 230ᵢ) may operate independent of the main processor 202 in the communication device 200, and may utilize dedicated software that is unique for a particular payment provider 120ᵢ for handling of secure transactions. In instances where the communication device 200 comprises a bank or pool of secure processors 230₁-230_{N}, a particular secure processor may be selected from the bank or pool of secure processors 230₁-230_{N} to handle a particular secure transaction. Furthermore, at least some of the secure processors 230₁-230_{N} may be operable to concurrently handle a plurality of secure transactions. Each secure processor (204 or 230ᵢ) may utilize one or more corresponding dedicated resources in the communication device 200 when handling secure transactions. The dedicated resources may comprise memory resource (206_{B} or 232ᵢ). The dedicated resources may comprise separate physical components, which may be used only by the secure processor(s. Dedicated resources may also be allocated or partitioned from commonly shared components in the communication device 200.

During handling of the secure transactions, communication pertaining to the secure transaction may be performed via a shared communication subsystem 230, which may be utilized by both secure and non-secure components in the communication device 200, or via a dedicated, secure communication subsystem 250_{B}, which may be utilized only when handling secure transactions. During handling of the secure transactions, the user and/or the transaction or request thereof may be authenticated by, for example, the user authentication module 208. In this regard, authentication of the user and/or the transaction may be based on information related to and/or provided by the user, which may be obtained, captured, or generated using the plurality of user input modules 300₁-300₄. The information may comprise one or more of biometric data, user access information, and security access information.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for dedicated secure processor for handling secure transactions in a handheld communication device.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
in a communication device comprising one or more dedicated secure processors, and one or more other processors:
securely handling by at least one of said one or more dedicated .secure processors, a secure transaction for a user of said communication device, wherein:
each of said one or more dedicated secure processors operate independent of said one or more other processors in said communication device; and
each of said one or more dedicated secure processors utilizes dedicated software that is unique for a particular payment provider for handling of secure transactions.

2. The method of claim 1, wherein said secure transaction is initiated by said user.

3. The method of claim 1, wherein a plurality of said one or more dedicated secure processors within said communication device are operable to concurrently handle a plurality of secure transactions.

4. The method of claim 1, wherein each of said one or more dedicated secure processors utilizes one or more dedicated resources in said communication device during handling of secure transactions.

5. The method of claim 4, wherein said one or more dedicated resources comprise storage resources.

6. The method of claim 4, wherein:
said one or more dedicated resources comprise one or more of separate physical components used only by said one or more dedicated secure processors; and/or
said one or more dedicated resources are allocated or partitioned from commonly shared components in said communication device.

7. The method of claim 1, comprising communicating, during said handling of said secure transaction, via a communication subsystem shared with other components in said communication device, or via a dedicated communication subsystem, which is utilized only for handling secure transactions.

8. The method of claim 1, comprising authenticating said user and/or said transaction during said handling.

9. The method of claim 8, comprising authenticating said user and/or said transaction based on information relating to and/or provided by said user.

10. The method of claim 9, wherein said information comprise one or more of biometric data, user access information, and security access information.

11. A system comprising
one or more circuits in a communication device, said one or more circuits comprising one or more dedicated secure processors and one or more other processors, said one or more circuits being operable to securely handle by at least one of said one or more dedicated secure processors, a secure transaction for a user of said communication device, wherein:
each of said one or more dedicated secure processors operate independent of said one or more other processors in said communication device; and
each of said one or more dedicated secure processors utilizes dedicated software that is unique for a particular payment provider for handling of secure transactions.

12. The system of claim 11, wherein said secure transaction is initiated by said user.

13. The system of claim 11, wherein a plurality of said one or more dedicated secure processors within said communication device are operable to concurrently handle a plurality of secure transactions.

14. The system of claim 11, wherein each of said one or more dedicated secure processors utilizes one or more dedicated resources in said communication device during handling of secure transactions.

15. The system of claim 14, wherein said one or more dedicated resources comprise storage resources.

16. The system of claim 14, wherein:
said one or more dedicated resources comprise one or more of separate physical components used only by said one or more dedicated secure processors; and/or
said one or more dedicated resources are allocated or partitioned from commonly shared components in said communication device.

17. The system of claim 11, wherein said one or more circuits are operable to communicate, during said handling of said secure transaction, via a communication subsystem shared with other components in said communication device, or via a dedicated communication subsystem, which is utilized only for handling secure transactions.

18. The system of claim 11, wherein said one or more circuits are operable to authenticate said user and/or said transaction during said handling.

19. The system of claim 18, wherein said one or more circuits are operable to authenticate said user and/or said transaction based on information relating to and/or provided by said user.

20. The system of claim 19, wherein said information comprise one or more of biometric data, user access information, and security access information.
